(19) United States
(12) Patent Application Publication
(10) Pub. No.: US 2010/0079780 A1
(43) Pub. Date: Apr. 1, 2010

(54) IMAGE FORMING APPARATUS, IMAGE FORMING SYSTEM, AND JOB HISTORY DISPLAYING METHOD THEREOF

(75) Inventor: Won-jae LEE, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/535,043

(22) Filed: Aug. 4, 2009

(30) Foreign Application Priority Data
Sep. 29, 2008 (KR) 2008-95520

(51) Int. Cl. G06F 3/12; G06F 15/00

(52) U.S. Cl. 358/1.13; 358/1.16

(57) ABSTRACT

An image forming apparatus, an image forming system and a job history displaying method of the image forming apparatus. The job history displaying method of the image forming apparatus which performs at least one function of printing, scanning, copying and facsimile, includes: performing a job which is supported in the image forming apparatus; storing a job history which includes the performed job; and displaying a job history with respect to at least one function among the stored job history in at least one display unit of date, day, week, month and year.

### CROSS-REFERENCE TO RELATED APPLICATIONS

This application claims priority from Korean Patent Application No. 10-2008-0095520, filed in the Korean Intellectual Property Office on Sep. 29, 2008, the disclosure of which is incorporated herein by reference.

### BACKGROUND OF THE INVENTION

1. Field of the Invention

Aspects of the present invention relate to an image forming apparatus, an image forming system and a job history displaying method of the image forming apparatus, and more particularly, to an image forming apparatus, an image forming system and a job history displaying method of the image forming apparatus allowing a user to immediately confirm a job history.

2. Description of the Related Art

Image forming apparatuses include printers, scanners, copiers, facsimile machines, and multifunction devices, and generally include a function supplying to a user a history of jobs performed by the image forming apparatus, referred to as a job history. A conventional image forming apparatus displays the above job history in a display unit in a list type according to a predetermined order, such as time, function, etc. If a list about the job history is greater than a displayable range in the display unit, just a part of the job history is displayed in the display unit.

If information which the user wants to confirm is not displayed in the display unit, it is necessary for the user to inconveniently perform an additional function, such as scrolling a display list, etc. to search for the desired record. Since the job history is displayed as a list, it is difficult for the user to intuitively find a desired job history.

### SUMMARY OF THE INVENTION

Aspects of the present invention provide an image forming apparatus, an image forming system and a job history displaying method thereof managing and displaying a job history by year, month and date to allow a user to immediately confirm the job history.

According to an aspect of the present invention a job history displaying method of an image forming apparatus, which is capable of performing a function of printing, scanning, copying, and/or facsimile, is provided. The job history displaying method of the image forming apparatus includes: performing a job supported in the image forming apparatus; storing a job history relating to the performed job; and displaying the job history with respect to at least one function among the stored job history in an indication unit of day, week, month and year.

According to another aspect of the present invention, the displaying of the job history may include dividing a screen into a plurality of areas by each indication unit, and displaying the job history in at least one of the plurality of areas.

According to another aspect of the present invention, the job history displaying method of the image forming apparatus may further include selecting a job history which is displayed in the area.

According to another aspect of the present invention, if a job history with respect to one function among the job history of the image forming apparatus is selected, a subordinate item with respect to the selected job history may be displayed.

According to another aspect of the present invention, if at least one area of the plurality of areas is selected, detailed information about a job history of the image forming apparatus corresponding to the selected area may be displayed.

According to another aspect of the present invention, the detailed information may include job kind, job day and time, user information, rerunning, and.or job conversion execution.

According to another aspect of the present invention, the job history displaying method of the image forming apparatus may further include certifying a user or a manager using the image forming apparatus.

According to another aspect of the present invention, if the user is certified, the job history of the image forming apparatus with respect to the certified user may be displayed, and if the manager is certified, the job history of the image forming apparatus with respect to total users may be displayed.

According to another aspect of the invention, the displaying operation may include displaying the job history in a first display unit of the image forming apparatus and/or a second display unit of a host.

According to another aspect of the present invention, an image forming apparatus is provided. The apparatus includes: an image forming unit to perform a of printing, scanning, copying, and/or facsimile; a storing unit to store a job history including a performed job; a display unit to display a job history respect to at least one function of the job history of the image forming unit stored in the storing unit; and a control unit to control the display unit to display the job history displayed in the display unit by an indication unit of day, week, month, and/or year.

According to another aspect of the present invention, the display unit may display a frame screen divided into a plurality of areas by each indication unit, and the control unit controls the display unit to display the job history in at least one area on the frame screen.

According to another aspect of the present invention, the image forming apparatus may further include a selecting unit to select a job history displayed in the area.

According to another aspect of the present invention, ff a job history with respect to one function among the job history of the image forming unit is selected by the selecting unit, the control unit may control the display unit to display a subordinate item with respect to the selected job history.

According to another aspect of the present invention, if at least one area of the plurality of areas is selected, the control unit may control the display unit to display a detailed information about a job history corresponding to the selected area.

According to another aspect of the present invention, the job history displayed in the display unit may be classified and displayed by a date indication unit, and the frame screen may be displayed in a month calendar type including an area for each date.

According to another aspect of the present invention, the image forming apparatus may further include a certifying unit to certify a user or a manager using the image forming apparatus, wherein, if the user is certified, the control unit controls the display unit to display the job history of the image forming unit with respect to the certified user, and if the manager is certified, the control unit controls the display unit to display the job history of the image forming unit with respect to total users.

According to another aspect of the present invention, an image forming system is provided. The image forming system includes: an image forming apparatus comprising an image forming unit to perform a function of printing, scanning, copying, and/or facsimile, a storing unit to store a job history including a performed job, a first display unit to display the job history of the image forming unit, and a first control unit to control the first display unit and to supply the job history stored in the storing unit to an external device; and a host to receive the job history from the image forming apparatus and comprising a second display unit to display the job history of the image forming unit, and a second control unit to control the image forming apparatus and the second display unit, wherein the first control unit and/or the second control unit control the first and second display units so that the job history displayed in the first display unit and/or the second display unit can be displayed in at least one indication unit of day, week, month, and year.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an image forming system including an image forming apparatus according to an embodiment of the present invention;

FIGS. 2 to 4 respectively illustrate examples of job history display screens displayed in a first display unit of the image forming apparatus or a second display unit of a host according to an embodiment of the present invention; and

FIG. 5 is a flowchart describing a job history displaying method of an image forming apparatus according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below so as to explain the present invention by referring to the figures. Repetitive description with respect to like elements of different embodiments may be omitted for the convenience of clarity.

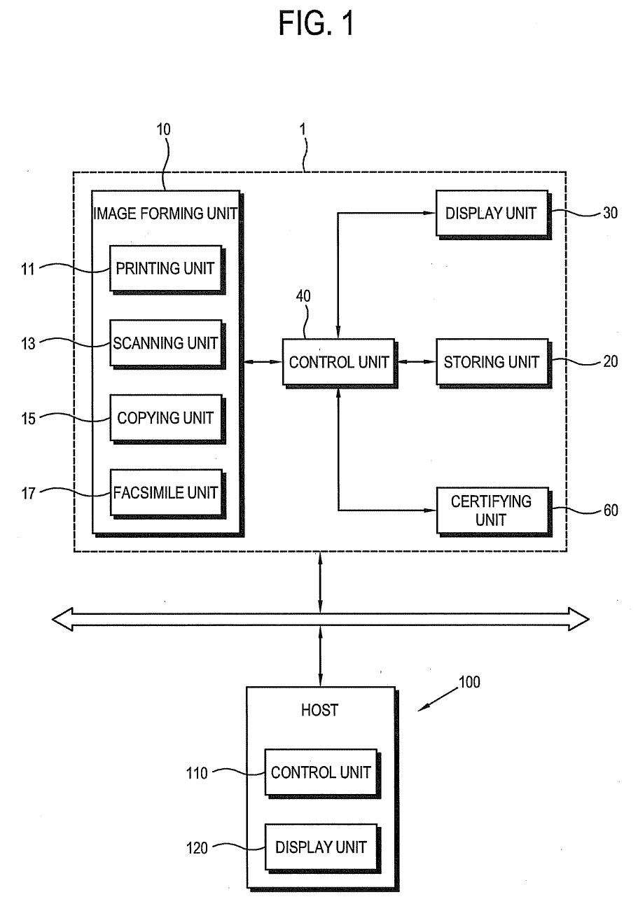

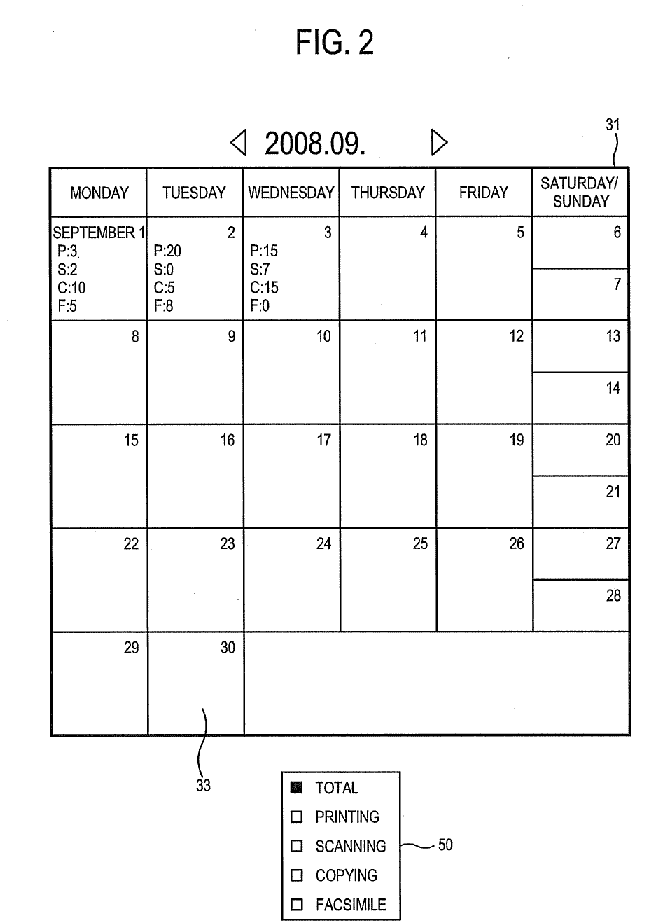

FIG. 1 illustrates an image forming system including an image forming apparatus 1 according to an embodiment of the present invention, and FIGS. 2 to 4 respectively illustrate examples of job history display screens displayed in a first display unit of the image forming apparatus or a second display unit of a host according to an embodiment of the present invention. As shown in FIG. 1, an image forming system according to an embodiment of the present invention includes the image forming apparatus 1 and a host 100 connected with the image forming apparatus 1 through a network, such as a local area network (LAN). The network may be a wired or wireless network and may employ any network technology.

The image forming apparatus 1 includes an image forming unit 10, a storing unit 20 in which a job history of the image forming unit 10 is stored, a first display unit 30 in which the job history is displayed, and a first control unit 40 controlling the first display unit 30 to classify the job history displayed in the first display unit 30 by at least one indication unit of date, day, week, month and year. According to other aspects of the present invention, the image forming apparatus 1 may include additional and/or different units. Similarly, the functionality of two or more of the above units may be integrated into a single component.

The image forming apparatus 1 may be implemented as an electrophotographic image forming apparatus forming an image on a printing medium supplied from a feeding cassette through charging, exposing, developing, transferring and fusing processes; an inkjet type image forming apparatus; or another type of image forming apparatus. The image forming unit 10 may include one or more of a printing unit 11 printing a visible image on a printing medium, a scanning unit 13 scanning an image out of a document, a copying unit 15, and/or a facsimile unit 17 transferring an image. The image forming apparatus 1 may include a multifunction unit performing at least two of the printing, scanning, copying and facsimile functions.

The host 100 may be implemented as a general purpose host computer, such as a personal computer, server, or laptop, and may employ a printer driver to order a document printing, an environment setting, etc., to the image forming apparatus 1. The host 100 includes a second control unit 110 and a second display unit 120. The second control unit 110 supplies an operating command with respect to the image forming apparatus 1, and controls the second display unit 120.

Referring to FIGS. 1 to 3, the first display unit 30 includes a frame screen 31 partitioning a screen into a plurality of areas 33. The first display unit 30 may be implemented as a touch screen allowing a touch input against the total surface, although the display unit may be implemented as other types of displays.

The first control unit 40 controls the first display unit 30 so that a job history can be displayed in at least one area 33 in the frame screen 31. The second control unit 110 controls the second display unit 120 so that a job history can be displayed in at least one area 33 in the frame screen 31.

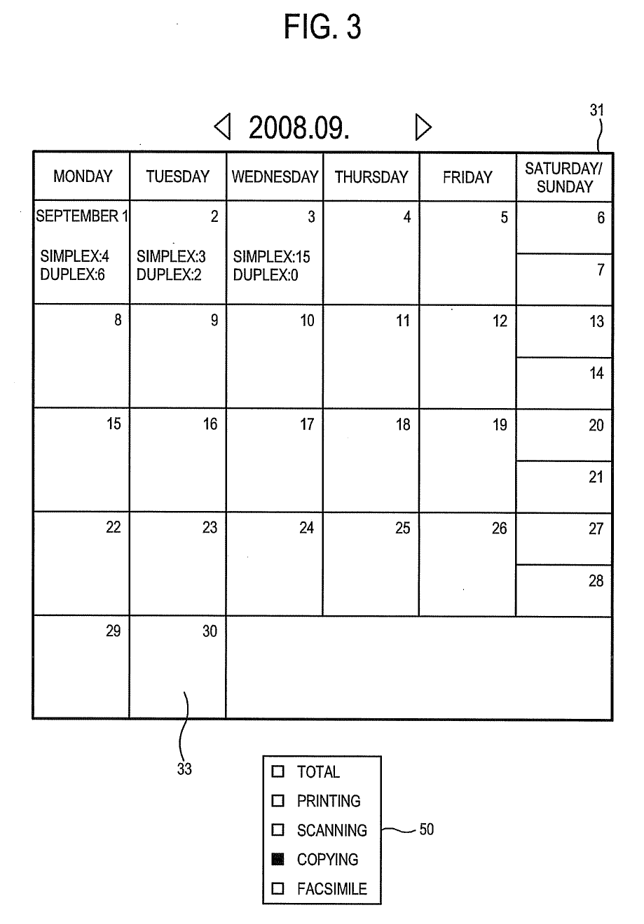

FIGS. 2 and 3 illustrate examples embodied in a month calendar type having an area by date in embodying the frame screen 31. In this case, the job history of the image forming unit 10 is classified by a date indication unit to be displayed. For example, the frame screen 31 may be implemented in a month calendar type representing September, 2008.

The image forming apparatus 1 may further include a selecting unit 50 selecting a job history displayed in the areas 33. The selecting unit 50 selects whether to display total job contents with respect to each area 33 or to select and display one or more job contents among the printing, scanning, copying, and/or facsimile functions. FIG. 2 illustrates a case in which ‘total’ job history is selected. As shown in FIG. 2, in the areas corresponding to September 1, 2, and 3, a usage record about the number of usage times by the printing P, scanning S, copying C and facsimile F is displayed. If the number of the usage times is zero, (for example, the job contents about the facsimile F on Wednesday, September 3 as shown in FIG. 2) zero (0) may be displayed or no information about facsimile jobs may be displayed.

If a job history with respect to one function of the job history of the image forming unit 10 is selected by the selecting unit 50, the first control unit 40 may control the first display unit 30 so that a subordinate item about the selected job history can be displayed in the areas 33. FIG. 3 illustrates a case that the ‘copying’ job is selected. In this case, information about the numbers of single surface copying times and double surface copying times is displayed in the areas 33. For example, in an area corresponding to September 1, comparing FIGS. 2 and 3, the total number with respect to the copying 10 times is displayed in selecting the ‘total’ job history as shown in FIG. 2. Subordinate item information, such as the single surface copying 4 times and the double surface copy 6 times, is displayed in selecting the ‘copy’ job contents as shown in FIG. 3.

Subordinate items by each job history may include sending a scan image to an E-mail (scan to E-mail), sending to a storing unit of a server (scan to server), sending to a storing unit by each user in the apparatus (scan to box), etc., for the ‘scan’ job history. Subordinate items for the ‘printing’ job history may include ‘monochrome printing’, ‘color printing’, ‘simplex printing’, ‘duplex printing’, etc. Subordinate items for the ‘facsimile’ job history may include ‘facsimile receiving’, ‘facsimile sending’, etc.

If one area of the plurality of areas 33 is selected, the first control unit 40 controls the first display unit 30 so that detailed information about the job history of the image forming unit 10 corresponding to the selected area can be displayed. The detailed information may include job kind, job day and time, user information, rerunning, and/or job conversion execution.

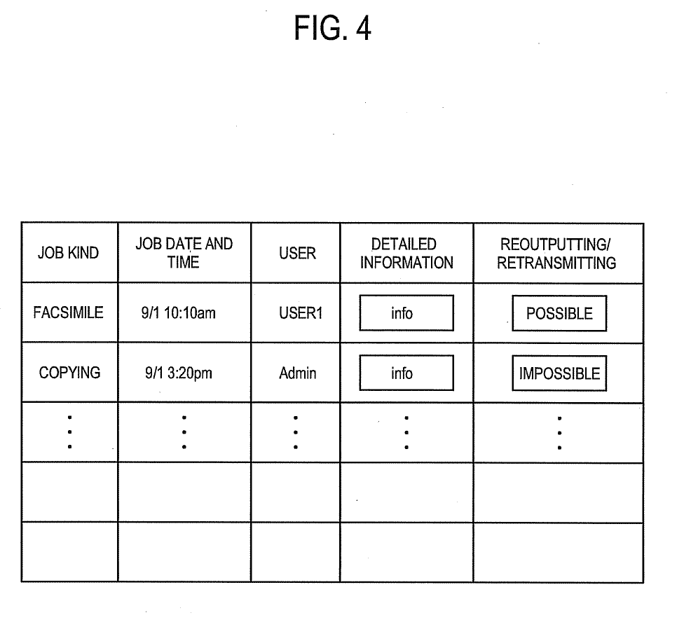

FIG. 4 illustrates a case of selecting September 1 among the areas in FIG. 2. In this case, the job kind (facsimile, copying, . . . ), the job day and time, the user information, the detailed information about each job item, etc. are displayed in the first display unit 30. Reoutputting/retransmitting information is information representing whether to rerun a previously processed job. For example, as shown in FIG. 4, in case of the ‘facsimile’, which is the first detail item, the reoutputting/retransmitting item is displayed as ‘enable’. In this case, it is possible for a user to execute the previously processed job contents again, or may convert the job kind to execute. On the other hand, the reoutputting/retransmitting item for ‘copying’, which is the second detailed item, is displayed as ‘disable’, indicating that it is impossible to execute again, or to convert the job kind to execute. FIG. 4 illustrates a case of selecting single specific date, but aspects of the present invention are not defined thereto. More than two dates may be selected, and in this case, the detailed information about the selected dates may be displayed in the type as shown in FIG. 4.

The image forming apparatus 1 may further include a certifying unit 60 certifying a user or a manager using the apparatus. In this case, the first control unit 40 may classify the job history into a user and a manager in displaying the job history. If a user is identified, the first display unit 30 may be controlled so that only job history of the certified user can be displayed in the first display unit 30. If a manager is identified, the first display unit 30 may be controlled so that the job history of the image forming unit 10 with respect to all users can be displayed.

As described above, the display screen is shown in the month calendar type having the area by each date. Other aspects of the present invention may employ a week calendar type displaying in a single week unit and other various changes.

As described above, the job history is displayed in the first display unit 30. Alternatively, a job history of the image forming unit 10 may be displayed in the second display unit 120 by the second control unit 110, and a job history may be selected from the job history displayed in the second display unit 120. In this case, the image forming apparatus 1 may include an embedded web server (EWS), and the job history may be displayed and/or selected by using a web browser installed in the host 100. The job history may be configured to be displayed in both the first display unit 30 and the second display unit 120.

As described above, the image forming system according to aspects of the present invention classifies and displays the job contents of the image forming unit in an indication unit of day, week, month and/or year, thereby allowing a user to intuitively grasp the job history of the corresponding indication unit. When the job history is displayed in the month calendar type having an area for each day, the job history of the image forming apparatus can be easily viewed through the detailed information depending on selecting the brief information for a job displayed in an area corresponding to the date. By displaying whether to rerun in the detailed information, the previously used information can be easily reused if the rerunning is possible.

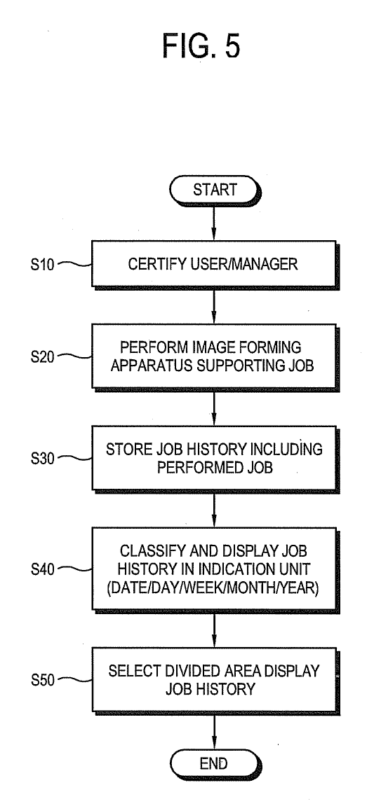

FIG. 5 is a flowchart describing a job history displaying method of an image forming apparatus according to an embodiment of the present invention. The method may be applied to an image forming apparatus performing at least one function of printing, scanning, copying and facsimile. The job history displaying method includes an operation S20 of performing a job which the image forming apparatus is capable of supporting , an operation S30 of storing a job history including the performed job, and an operation S40 of classifying and displaying the stored job history in a predetermined indication unit. In the displaying operation S40, a job history is classified with respect to at least one function among the stored job history in at least one indication unit of date, day, week, month and year. The job history is displayed in operation S40 on a first display unit 30 of an image forming apparatus 1 and/or a second display unit 120 of a host 100. As shown in FIG. 2, the screen may be divided in operation S40 into a plurality of areas 33 by each indication unit, and the job history in at least one area is displayed.

The job history displaying method may further include an operation S50 of selecting a job history displayed in the areas 33. If a job history with respect to one function of the job history of the image forming apparatus 1 is selected, a subordinate item about the selected job history may be displayed. If at least one area of the plurality of areas is selected, detailed information about the job history of the image forming apparatus 1 corresponding to the selected area is displayed. The detailed information may include at least one of job kind, job day and time, user information, and job conversion execution. The job history selecting operation S50 may have the same configuration as the job contents selecting type described above by referring to FIGS. 2 to 4.

The job history displaying method may further include an operation S10 of certifying a user or a manager using the image forming apparatus 1. If the user is identified in the certifying operation S10, the job history displayed in the first display unit 30 is limited to information about the identified user. If the manager is identified in the certifying operation S10, job histories of the image forming apparatus 1 about all total users are displayed.

As described above, the image forming apparatus, the image forming system and the job history displaying method of the image forming apparatus according to aspects of the present invention classify and display the job contents of the image forming unit in at least one indication unit of the data, day, week, month and year, thereby allowing a user to intuitively grasp the job history of the corresponding display unit. With a display screen formatted in the month calendar type, the job history of the image forming apparatus can be easily seen through selected detailed information corresponding to the displayed brief information. By displaying in the detailed information whether a job can be rerun, the previously used information can be easily reused if possible.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A job history displaying method of an image forming apparatus capable of performing a printing, scanning, copying, and/or facsimile function, the job history displaying method of the image forming apparatus comprising:
performing a job supported in the image forming apparatus;
storing a job history relating to the performed job; and
displaying the job history with respect to at least one function among the stored job history in an indication unit of day, week, month, and/or year, in a display unit.

2. The job history displaying method according to claim 1, wherein the displaying of the job history comprises dividing a screen into a plurality of areas by each indication unit, and displaying the job history in at least one of the plurality of areas.

3. The job history displaying method according to claim 2, further comprising selecting a job history which is displayed in the area.

4. The job history displaying method according to claim 3, wherein, if a job history with respect to one function among the job history of the image forming apparatus is selected, a subordinate item with respect to the selected job history is displayed.

5. The job history displaying method of the image forming apparatus according to claim 2, wherein, if at least one area of the plurality of areas is selected, detailed information about a job history of the image forming apparatus corresponding to the selected area is displayed.

6. The job history displaying method according to claim 5, wherein the detailed information comprises job kind, job day and time, user information, rerunning, and/or job conversion execution.

7. The job history displaying method according to claim 1, further comprising certifying a user or a manager using the image forming apparatus.

8. The job history displaying method according to claim 7, wherein, if the user is certified, the job history of the image forming apparatus with respect to the certified user is displayed, and if the manager is certified, the job history of the image forming apparatus with respect to total users is displayed.

9. The job history displaying method according to claim 1, wherein the displaying of the job history comprises displaying the job history in a first display unit of the image forming apparatus and/or a second display unit of a host.

10. An image forming apparatus, comprising:
an image forming unit to perform a function of printing, scanning, copying, and/or facsimile;
a storing unit to store a job history relating to a performed job;
a display unit to display the job history with respect to at least one function of the job history of the image forming unit stored in the storing unit; and
a control unit to control the display unit to display the job history displayed in the display unit by an indication unit of day, week, month, and/or year.

11. The image forming apparatus according to claim 10, wherein the display unit displays a frame screen divided into a plurality of areas by each indication unit; and
the control unit controls the display unit to display the job history in at least one area on the frame screen.

12. The image forming apparatus according to claim 11, further comprising a selecting unit to select a job history displayed in the at least one area.

13. The image forming apparatus according to claim 12, wherein, if a job history with respect to one function among the job history of the image forming unit is selected by the selecting unit, the control unit controls the display unit to display a subordinate item with respect to the selected job history.

14. The image forming apparatus according to claim 11, wherein, if at least one area of the plurality of areas is selected, the control unit controls the display unit to display detailed information about a job history corresponding to the selected area.

15. The image forming apparatus according to claim 14, wherein the detailed information comprises job kind, job day and time, user information, rerunning, and/or job conversion execution.

16. The image forming apparatus according to claim 10, wherein:
the job history displayed in the display unit is classified and displayed by a date indication unit; and
the frame screen is displayed in a month calendar type comprising an area for each date.

17. The image forming apparatus according to claim 10, further comprising a certifying unit to certify a user or a manager using the image forming apparatus,
wherein, if the user is certified, the control unit controls the display unit to display the job history of the image forming unit with respect to the certified user, and if the manager is certified, the control unit controls the display unit to display the job history of the image forming unit with respect to total users.

18. An image forming system, comprising:
an image forming apparatus including an image forming unit to perform a function of printing, scanning, copying, and/or facsimile, a storing unit to store a job history comprising a performed job, a first display unit to display the job history of the image forming unit, and a first control unit to control the first display unit and to supply the job history stored in the storing unit to an external device; and
a host to receive the job history stored in the storing unit and comprising a second display unit to display the job history of the image forming unit, and a second control unit to control the image forming apparatus and the second display unit, wherein the first control unit and/or the second control unit control the first and second display units so that the job history displayed in the first display unit and/or the second display unit can be displayed in at least one indication unit of day, week, month, and year.

19. A method of displaying a job history of an image forming apparatus capable of at least one function of printing an image onto a printable medium, the method comprising:
storing a job history identifying a plurality of print jobs performed by the image forming apparatus; and
displaying information on a display unit about at least one of the print jobs included in the job history, the information arranged by day, week, month, and/or year.

20. The method of claim 19, wherein the information comprises detailed information on one of the print jobs included in the job history.
